(19) United States
(12) Patent Application Publication
(10) Pub. No.: US 2001/0039188 A1
(43) Pub. Date: Nov. 8, 2001

(54) Position-dependent call diversion

(76) Inventors: Walter Amereller, Munchen (DE); Andre Blitz, Munchen (DE)

Correspondence Address: Lerner and Greenberg, P.A., P. O. Box 2480, Hollywood, FL, 33022-2480, US

(21) Appl. No.: 09/745,564

(22) Filed: Dec. 21, 2000

(30) Foreign Application Priority Data
Dec. 21, 1999 (DE) 199 61 792.9

(51) Int. Cl. H04Q 7/20

(52) U.S. Cl. 455/417; 455/445

(57) ABSTRACT

A method providing automatic control of call diversion from a first terminal (TEG), which is coupled to a switching device (V), to any desired second terminal (MEG). The call diversion process is controlled as a function of the position of a mobile terminal (MEG) relative to a base station (BS1) which is coupled to the switching device (V). A measure for the relative position of the mobile terminal (MEG) is in this case determined on the basis of radio signals which are transmitted between the base station (BS1) and the mobile terminal (MEG).

### BACKGROUND OF THE INVENTION

### Field of the Invention

The invention relates to a method for controlling call diversion.

Many switching devices in present-day communications systems allow call diversions to be set up for terminals which are connected to the switching devices. The setting up and activation of a call diversion for a terminal has the effect that incoming calls for this terminal are transferred by the switching device for this terminal to another terminal which can be defined by the user. The term call diversion is also used in the following text to cover so-called call transfer, in which an incoming call for one terminal is first of all signaled to this terminal and is transferred to a transfer destination only if it is not answered.

Call diversion is often used to divert calls which are intended for a fixed terminal located at a user's workplace to another terminal when the user leaves his workplace. To do this, where a user leaves his workplace, he must activate an appropriate call diversion process in the switching device. In this case, for example, the user can define as the transfer destination a mobile or cordless terminal which he carries with him, a mailbox, or a work colleague's terminal. When call diversion is activated, the switching device then signals the incoming calls for the fixed terminal at the workplace on the terminal defined as the transfer destination. When the user returns to his workplace, he must once again explicitly deactivate call diversion, so that incoming calls are once again switched to the fixed terminal at his workplace.

The user inputs which need to be carried out on activation or deactivation of call diversion when leaving and when returning to the workplace are time-consuming and complex. Furthermore, there is a risk, for example, that, when he leaves his workplace, the user will forget to activate call diversion and, in consequence, will be temporarily unavailable for incoming calls.

### SUMMARY OF THE INVENTION

It is accordingly an object of the invention to provide a method for activating call diversion that overcomes the above-mentioned disadvantageous of the prior art methods of this general type and that allows for automatic control of call diversion on an as-required basis.

With the foregoing and other objects in view there is provided, in accordance with the invention a method for controlling call diversion that includes coupling a first terminal, for which call diversion is to be activated, to a switching device; determining a measure indicating a position of a mobile terminal relative to at least one base station using radio signals that are transmitted between the mobile terminal and the at least one base station; and using a switching device to control the call diversion as a function of the determined measure.

The method allows automatic control of call diversion for a first terminal to any desired second terminal as a function of a position or the capability to access a mobile terminal. To a certain extent, the mobile terminal may in this case be regarded as an indicator as to where a user who is carrying the mobile terminal with him is located and/or whether this user can be accessed for connection requests. In this context, the term mobile terminal also covers the so-called cordless terminal.

The process of controlling call diversion may include, for example, setting up, configuration, activation or deactivation of call diversion. For example, call diversion for a landline terminal at a user's desk can be activated when the user, together with his mobile terminal, leaves a predetermined area around his desk. The call diversion to be activated may be to any desired second terminal, such as to the mobile terminal itself, to a mailbox, to a work colleague's terminal, to the user's home connection, or to another mobile terminal of the user. In the case of the last-mentioned example, a call diversion process controlled by the method according to the invention can be used to provide so-called roaming to another mobile terminal, which may also belong to a different radio network than that of the mobile terminal being used as an indicator.

The method is essentially independent of the wire-free communication method used by the mobile terminal and the base station. For example, it is possible to use a mobile terminal to the Bluetooth, DECT and/or GSM Standard.

In accordance with an added feature of the invention, a distance measure for the distance between the mobile terminal and a base station can be determined as a measure for the position of the mobile terminal. Such a distance measure can be determined particularly easily from the received field strength or from the signal delay time of radio signals interchanged between the base station and the mobile terminal, either by the base station or by the mobile terminal.

The radio signals transmitted between the mobile terminal and a number of base stations can be evaluated in order to determine the position of the mobile terminal more precisely. For example, the distance between the mobile terminal and each of a number of base stations can be determined for this purpose, in order to use this to determine a measure for the position of the mobile terminal on the basis of geometric relationships. Furthermore, direction-finding can also be carried out from a number of base stations in order to determine the position of the mobile terminal. The mobile terminal position determined relative to the base stations can also be used, if the position of the first terminal is known, to determine a measure for the distance between the mobile terminal and this first terminal.

The measure for the position of the mobile terminal can be determined not only by the mobile terminal itself but also by a base station. Using the base station to determine this position has the advantage that the method according to the invention can be carried out with conventional mobile terminals, which do not require any modification for this purpose.

Once it has been determined, the measure for the position of the mobile terminal can be transmitted as such to the base station and/or to the switching device. As an alternative to this, the mobile terminal or the base station can also check the position measure which has been determined to find out whether the mobile terminal has gone outside a predetermined value frame, for example, a predetermined maximum distance from the base station, and a message can be transmitted to the base station and/or to the switching device only when this situation occurs. One advantage of transmitting a message is that the switching device need not itself evaluate the position of the mobile terminal. In this case, a control message, which is normally used or is standardized for direct control of call diversion processes, is preferably used as the message. There is thus no need for any intervention in the existing switching devices to carry out the method according to the invention.

The position of the mobile terminal can be checked particularly easily if the predetermined value frame is governed by the range of the wire-free link between the mobile terminal and the base station. In this case, a message is transmitted to the base station and/or to the switching device when the mobile terminal leaves the radio area of the base station.

In the situation when there are various base stations located within radio range with which the mobile terminal is authorized to set up a connection, a prioritization list can additionally be predetermined, for example in the mobile terminal, which indicates which of these base stations it is preferable for the mobile terminal to register with, in order to control the call diversion process. In this case, a base station can preferably be allocated a higher priority the closer it is to the first terminal. Base stations specified in the prioritization list may in this case also belong to different radio networks. The prioritization list also allows different priorities to be allocated to different radio networks.

With the foregoing and other objects in view there is also provided, in accordance with the invention a method for controlling call diversion that includes: coupling a first terminal, for which call diversion is to be activated, to a switching device; registering, with a base station that is coupled to the switching device, whether a mobile terminal other than the first terminal can be accessed for connection requests; and controlling the call diversion process, with the switching device, as a function of the registration.

Other features which are considered as characteristic for the invention are set forth in the appended claims.

Although the invention is illustrated and described herein as embodied in a method for position-dependent call diversion, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a communications system having a switching device with call diversion that has been set up but has not been activated; and

FIG. 2 shows the same communications system with call diversion activated.

### DESCRIPTION OF THE PREFERRED EMBODIMENTS

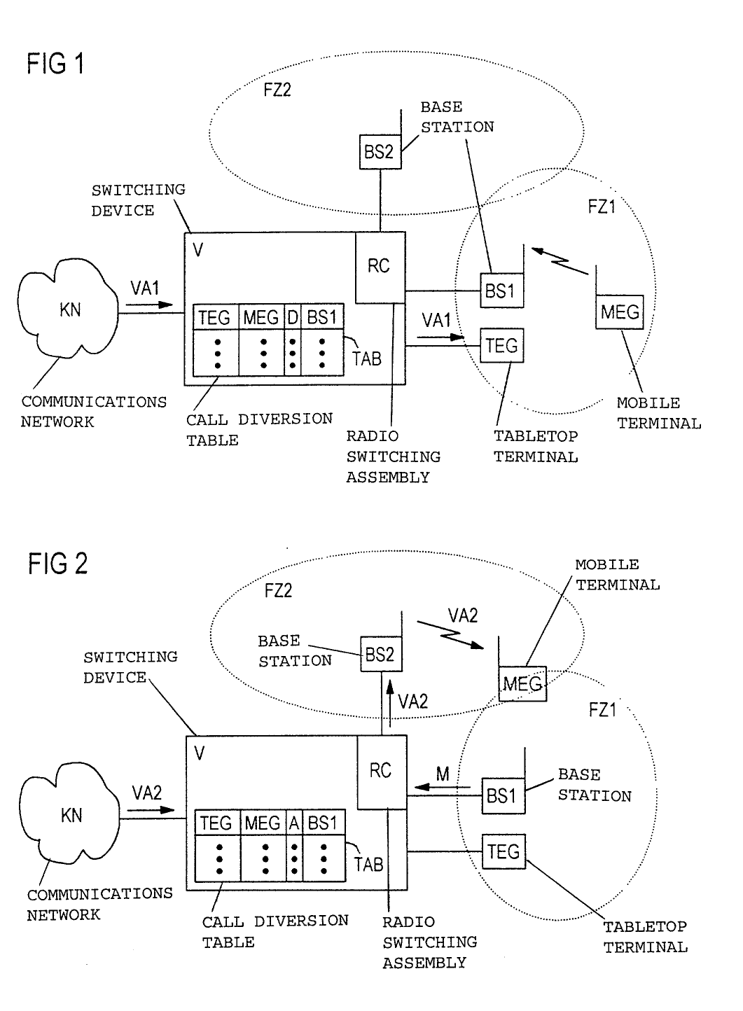

FIGS. 1 and 2 each schematically show a communications system having a switching device V, for example a so-called PBX system (PBX: private branch exchange) connected to a communications network KN. A fixed tabletop terminal TEG as well as base stations BS1 and BS2 are coupled to the switching device V. The radio cell FZ1 of the base station BS1 and the radio cell FZ2 of the base station BS2 are each indicated as dotted ellipses. The communications system also includes a mobile terminal MEG, which is authorized to set up connections both via the base station BS1 and via the base station BS2.

For the present exemplary embodiment, it is assumed that the base station BS1 is located in the immediate vicinity of the tabletop terminal TEG and that base station BS1 is a home base station or a base station prioritized in some other way for the mobile terminal MEG. The user of the tabletop terminal TEG is also assumed to be the user of the mobile terminal MEG, which he carries with him.

The base stations BS1 and BS2 may, for example, be in the form of DECT base stations (DECT: Digital Enhanced Cordless Telephony), which belong to the same or to different radio networks. In this case, the mobile terminal MEG is in the form of a cordless DECT terminal which is registered as being authorized to accept connections in both the joint and the different radio networks of the respective base stations BS1, BS2. As an alternative to this, the base station BS1 may also be in the form of a so-called Bluetooth module, which allows the mobile terminal MEG to be coupled over short distances to the switching device V via a Bluetooth module in the mobile terminal MEG.

The base stations BS1 and BS2 are each coupled to a radio switching assembly RC of the switching device V. The radio switching assembly RC is used to control the setting up of connections and the routing of connections to mobile terminals automatically via base stations which are connected to it. The switching device V also contains a call diversion table TAB in which call diversions to any desired terminals can be entered, for example by user inputs, for those terminals which are registered with the switching device V, in this case the fixed tabletop terminal TEG and the mobile terminal MEG. In the present exemplary embodiment, a call diversion to the mobile terminal MEG has been entered for the tabletop terminal TEG. No call diversion has been entered for the mobile terminal MEG itself.

In the call diversion table TAB, each terminal for which call diversion has been set up, in this case the tabletop terminal TEG, is allocated a respective destination terminal, in this case the mobile terminal MEG. For each terminal set up for call diversion, the call diversion table TAB contains an activation status, in this case A for Activated or D for Deactivated, and initiation information, in this case BS1. The initiation information in this case identifies those terminals, base stations, assemblies and/or events which can initiate control of the associated call diversion process. In the present exemplary embodiment, the initiation information identifies the base station BS1. This means that the call diversion process for the tabletop terminal TEG can be controlled by messages from the base station BS1.

FIG. 1 shows a situation in which the user is located, together with his mobile terminal MEG, in the immediate vicinity of the tabletop terminal TEG and of the base station BS1. The mobile terminal MEG is located within the radio cell FZ1, and within radio range of the base station BS1. The base station BS1 confirms that the mobile terminal MEG can be accessed by interchanging radio signals, as indicated by means of a stylized lightning symbol, and reports this to the radio switching assembly RC.

In the switching device, an appropriate entry in the call diversion table TAB causes call diversion to be set up for the tabletop terminal TEG to the mobile terminal MEG but this is initially identified as being deactivated by virtue of the activation status D allocated to the tabletop terminal TEG.

Since the call diversion which has been set up for the tabletop terminal TEG is still deactivated, connection requests VA1 arriving at the switching device V and whose destination is the tabletop terminal TEG are switched from the communications network KN to the tabletop terminal TEG. Since, as confirmed by the base station BS1, the user together with his mobile terminal MEG is located in the vicinity of the tabletop terminal TEG, the incoming connection requests VA1 can be received by the user on the tabletop terminal TEG.

FIG. 2 shows a situation in which the user, together with his mobile terminal MEG leaves the radio cell FZ1 of the base station BS1, and thus leaves a predetermined area around his tabletop terminal TEG. As soon as the base station BS1 finds that the mobile terminal MEG has left the radio cell FZ1, it sends a message M to the switching station V. The base station BS1 confirms that the terminal has left the radio cell FZ1 by comparing the received field strength of radio signals from the mobile terminal MEG with a predetermined limit value, which defines the range of the radio link.

The switching station V identifies the message M as coming from the base station BS1, and an entry with initiation information which identifies this base station BS1 is then determined in the call diversion table TAB. In the present exemplary embodiment, the entry which is determined relates to the previously deactivated call diversion for the tabletop terminal TEG to the mobile terminal MEG. This call diversion is then activated by the switching device V, and is identified as being active by entering an activation status A in the call diversion table TAB. Subsequent connection requests VA2 which are directed from the communications network KN to the tabletop terminal TEG are in consequence diverted by the switching device V to the mobile terminal MEG. The switching device V to this end passes on the connection requests VA2 to the radio switching assembly RC, which controls the rest of the process of setting up a wire-free connection to the mobile terminal MEG. In the present exemplary embodiment, it is assumed that, on leaving the radio cell FZ1, the mobile terminal MEG is located in the radio cell FZ2 of the base station BS2 and has registered with the radio switching assembly RC via the base station BS2, by interchanging radio signals with the base station BS2. This registration process causes the radio switching assembly RC to switch all incoming connection requests VA2 for the tabletop terminal TEG to the mobile terminal MEG via the base station BS2.

Thus, even when the user is away from his tabletop terminal TEG, he is accessible for calls directed to his tabletop terminal TEG.

Instead of call diversion to the mobile terminal MEG, the method according to the invention also makes it possible to control call diversions to any other desired terminals, which may also belong to a different communications system than that of the switching device V. Thus, for example, an appropriate entry for the tabletop terminal TEG in the call diversion table TAB allows call diversion to be activated to a mailbox, to a work colleague's tabletop terminal, to the user's home terminal or to another of the user's mobile terminals, whenever he leaves the radio cell FZ1. Call diversion to one of the user's mobile terminals other than the mobile terminal MEG is advantageous, for example, if the mobile terminal MEG is a cordless DECT terminal which has only a relatively short radio range (in the order of magnitude of 100 meters). In this case, call diversion to a GSM terminal (Global System for Mobile Communication), which can be accessed over a large area, can be activated as soon as the cordless DECT terminal MEG leaves the radio cell FZ1. This method is particularly advantageous when the DECT terminal MEG which initiates the activation of the call diversion process is integrated in the same mobile terminal as the GSM terminal.

Apart from the message M which is sent by the base station BS1 when the mobile terminal MEG leaves the radio cell FZ1, the base station BS1 may also transmit one or more other messages to the switching device V, depending on the position of the mobile terminal MEG found from the received field strength, and/or depending on its operating status. For example, if the received field strength rises, that is to say the mobile terminal MEG moves toward the base station BS1, a specific message which initiates deactivation of a previously activated call diversion can be transmitted to the switching device V.

In general, specific messages, which can be transmitted to the switching device V and which are used to control one or more call diversion processes in a predetermined manner, can in each case be provided for different position changes of the mobile terminal MEG, which can be detected by the base station BS1. For example, the base station BS1 can check the received field strength periodically in order to detect a change in the position of the mobile terminal MEG.

Furthermore, a message can be provided for the situation where the base station BS1 detects a change in the operating status of the mobile terminal, for example when the mobile terminal is switched on or is busy. For example, when the user takes a call on the mobile terminal MEG, a specific message can be transmitted to the switching device V, activating call diversion to the user's mailbox for the tabletop terminal TEG.

We claim:

1. A method for controlling call diversion, which comprises:
coupling a first terminal, for which call diversion is to be activated, to a switching device;
determining a measure indicating a position of a mobile terminal relative to at least one base station using radio signals that are transmitted between the mobile terminal and the at least one base station; and
using a switching device to control the call diversion as a function of the determined measure.

2. The method according to claim 1, wherein the measure indicating the position of the mobile terminal is determined as a distance measure indicating a distance between the mobile terminal and the at least one base station.

3. The method according to claim 1, which comprises using a received field strength of the radio signals to determine the measure indicating the position of the mobile terminal.

4. The method according to claim 1, which comprises evaluating radio signals which are transmitted between the mobile terminal and a plurality of base stations to determine the measure indicating the position of the mobile terminal.

5. The method according to claim 4, which comprises:
determining a distance measure indicating a distance between the mobile terminal and the first terminal; and
using the distance measure as the measure indicating the position of the mobile terminal.

6. The method according to claim 1, which comprises determining, in the at least one base station, the measure indicating the position of the mobile terminal.

7. The method according to claim 1, which comprises:
determining, with the mobile terminal, the measure indicating the position of the mobile terminal; and
transmitting the measure from the mobile terminal to a base station.

8. The method according to claim 1 which comprises:
determining, in the at least one base station, the measure indicating the position of the mobile terminal;
if the measure indicating the position of the mobile terminal goes outside a predetermined value frame, transmitting, with the at least one base station, a message to the switching device; and subsequently
in a predetermined manner, performing the step of controlling the call diversion using the switching device.

9. The method according to claim 1, which comprises:
determining, in the at least one base station, the measure indicating the position of the mobile terminal;
transmitting, from a base station to the switching device, the measure indicating the position of the mobile terminal; and
if the transmitted measure goes outside a predetermined value frame, then in a predetermined manner performing the step of controlling the call diversion using the switching device.

10. The method according to claim 1, which comprises:
determining, with the mobile terminal, the measure indicating the position of the mobile terminal;
if the measure goes outside a predetermined value frame, transmitting a message to a base station; and
initiating, with the base station, the control of the call diversion.

11. The method according to claim 10 wherein:
the transmitted message includes control information that identifies the first terminal and a second terminal;
the control information is for controlling the call diversion; and
the call diversion involves the first terminal and the second terminal.

12. The method according to claim 10, wherein the predetermined value frame is governed by a range of a wire-free link between the mobile terminal and the at least one base station.

13. The method according to claim 10, which comprises predetermining various value frames such that a value-frame-specific call diversion process is initiated when the measure indicating the position of the mobile terminal goes outside each respective one of the value frames.

14. The method according to claim 10 which comprises predetermining a terminal-specific value frame for a plurality of mobile terminals.

15. A method for controlling call diversion, which comprises:
coupling a first terminal, for which call diversion is to be activated, to a switching device;
registering, with a base station that is coupled to the switching device, whether a mobile terminal other than the first terminal can be accessed for connection requests; and
controlling the call diversion process, with the switching device, as a function of the registration.

16. The method according to claim 15, wherein if there are a plurality of base stations within radio range of the mobile terminal, the mobile terminal uses a predetermined prioritization list to determine which one of the plurality of base stations is preferable for the mobile terminal to register with, in order to control the call diversion process.

17. The method according to claim 15 which comprises controlling a terminal-specific call diversion process for each of a plurality of mobile terminals.
